(19) United States
(12) Patent Application Publication
(10) Pub. No.: US 2013/0271443 A1
(43) Pub. Date: Oct. 17, 2013

(54) DRIVING CIRCUIT OF BACKLIGHT MODULE AND DISPLAY APPARATUS USING THE SAME

(71) Applicants: Fei Li, Shenzhen (CN); Xinming Gao, Shenzhen (CN); Xiang Yang, Shenzhen (CN)

(72) Inventors: Fei Li, Shenzhen (CN); Xinming Gao, Shenzhen (CN); Xiang Yang, Shenzhen (CN)

(73) Assignee: Shenzhen China Star Optoeletronics Technology Co., Ltd., Shenzhen, Guangdong (CN)

(21) Appl. No.: 13/511,542

(22) PCT Filed: May 2, 2012
(86) PCT No.: PCT/CN2012/074972

§ 371 Date: May 23, 2012

(30) Foreign Application Priority Data
Apr. 16, 2012 (CN) 201210109891.5

(51) Int. Cl. G09G 5/00

(52) U.S. Cl. 345/212; 345/211

(57) ABSTRACT

The present invention provides a driving circuit of a backlight module and a display apparatus using the same. The driving circuit comprises at least one transistor connected to light-emitting diodes (LEDs), a constant-current circuit connected to the transistor, a power resist connected to the transistor in parallel; and a power switch connected between the transistor and the power resist, wherein a switch signal is transmitted to the power switch, and a signal level of the switch signal in a three-dimensional (3D) image mode is higher than another signal level of the switch signal in a two-dimensional (2D) image mode. The present invention can be applicable to the display apparatus for raising a brightness of the backlight module in the 3D image mode.

### FIELD OF THE INVENTION

The present invention relates to a driving circuit of a backlight module and a display apparatus using the same, and more particularly to a driving circuit of a backlight module and a display apparatus using the same applicable to switch between two-dimensional (2D) images/three-dimensional (3D) images.

### BACKGROUND OF THE INVENTION

Liquid crystal displays (LCDs) have been widely applied in electrical products. Currently, most of LCDs are backlight type LCDs which comprise a liquid crystal panel and a backlight module. According to the position of the backlight source, the backlight module can be a side-light type or a direct-light type in order to provide LCDs with backlight.

Light emitting diodes (LEDs) have several beneficial characteristics, including low electrical power consumption, low heat generation, long operational life, small volume, good impact resistance, fast response and excellent stability for emitting color light with stable wavelengths. These characteristics have made the LEDs suitable for light sources of the backlight module.

Currently, a display apparatus capable of displaying 2D/3D images has been developed. In general, the display apparatus which is capable of switching 2D/3D images comprises a 2D display panel and a parallax barrier panel. When displaying 2D images, the parallax barrier panel is in a transparent state, thereby allowing the 2D images of the 2D display panel to be shown. When displaying 3D images, the parallax barrier panel can form a plurality of parallax barriers, and a 3D image effect can be formed by using the parallax barriers. In a 3D image mode, a brightness of the 2D display panel will be reduced by the parallax barriers, and thus a brightness of the backlight module is required to be raised for compensating the brightness loss of the 2D display panel.

However, in an LED driving circuit, a driving current outputted from a conventional driving IC chip is limited, such as of 300 mA, and it is necessary to use more than one chip, thereby deteriorating an accuracy of controlling the driving current and a design complexity, as well as increasing a cost of the driving circuit.

As a result, it is necessary to provide a driving circuit of a backlight module and a display apparatus using the same to solve the problems existing in the conventional technologies, as described above.

### SUMMARY OF THE INVENTION

The present invention provides a driving circuit of a backlight module and a display apparatus using the same, so as to solve the limited current problem existing in the conventional driving circuit.

A primary object of the present invention is to provide a driving circuit of a backlight module, and the driving circuit comprises: at least one transistor connected to light-emitting diodes (LEDs); a constant-current circuit connected to the transistor; a power resist connected to the transistor in parallel; and a power switch connected between the transistor and the power resist, wherein a switch signal is transmitted to the power switch, and a signal level of the switch signal in a three-dimensional (3D) image mode is higher than another signal level of the switch signal in a two-dimensional (2D) image mode.

Another object of the present invention is to provide a driving circuit of a backlight module, and the driving circuit comprises: at least one transistor connected to LEDs; a constant-current circuit connected to the transistor; a power resist connected to the transistor in parallel; and a power switch connected between the transistor and the power resist, wherein a switch signal is transmitted to the power switch, and a signal level of the switch signal in a 3D image mode is higher than another signal level of the switch signal in a 2D image mode, and the signal level of the switch signal in the 3D image mode is higher than 2.5 V, and the another signal level of the switch signal in the 2D image mode is lower than 0.8 V.

Still another object of the present invention is to provide a display apparatus, and the display apparatus comprises a display panel and a backlight module, and the backlight module comprises: a back bezel; a plurality of LEDs disposed on the back bezel; and a driving circuit electrically connected to the LEDs, wherein the driving circuit comprises: at least one transistor connected to the LEDs; a constant-current circuit connected to the transistor; a power resist connected to the transistor in parallel; and a power switch connected between the transistor and the power resist, wherein a switch signal is transmitted to the power switch, and a signal level of the switch signal in a 3D image mode is higher than another signal level of the switch signal in a 2D image mode.

In one embodiment of the present invention, the signal level of the switch signal in the 3D image mode is higher than 2.5 V.

In one embodiment of the present invention, the signal level of the signal level of the switch signal in the 3D image mode is in the range of 2.5 V to 3.3 V.

In one embodiment of the present invention, the another signal level of the switch signal in the 2D image mode is lower than 0.8 V.

In one embodiment of the present invention, the driving circuit further comprises a multiplier configured to multiply the switch signal and a pulse width modulation (PWM) signal, and to provide a multiplied signal to the power switch.

In one embodiment of the present invention, the driving circuit further comprises a resist connected to the transistor.

In one embodiment of the present invention, the constant-current circuit comprises a regulator and an amplifier, and the regulator is connected between the power source and the amplifier, and the amplifier is connected to the transistor.

In one embodiment of the present invention, the regulator is a low drop-out linear regulator.

In one embodiment of the present invention, a current value of the LEDs in the 3D image mode is twice another current value of the LEDs in the 2D image mode.

With the use of the driving circuit of the backlight module and the display apparatus using the same, the driving circuit can be simplified, and only one driving IC chip is required, thereby enhancing a control accuracy of the driving current, as well as reducing a cost of the driving circuit.

The structure and the technical means adopted by the present invention to achieve the above and other objects can be best understood by referring to the following detailed description of the preferred embodiments and the accompanying drawings.

### DESCRIPTION OF THE DRAWINGS

FIG. 1 is a cross-sectional view showing a display apparatus according to one embodiment of the present invention; and

FIG. 2 is a circuit diagram showing the driving circuit according to one embodiment of the present invention.

### DETAILED DESCRIPTION OF THE PREFERRED EMBODIMENTS

The following embodiments are referring to the accompanying drawings for exemplifying specific implementable embodiments of the present invention. Furthermore, directional terms described by the present invention, such as upper, lower, front, back, left, right, inner, outer, side and etc., are only directions by referring to the accompanying drawings, and thus the used directional terms are used to describe and understand the present invention, but the present invention is not limited thereto.

In the drawings, structure-like elements are labeled with like reference numerals.

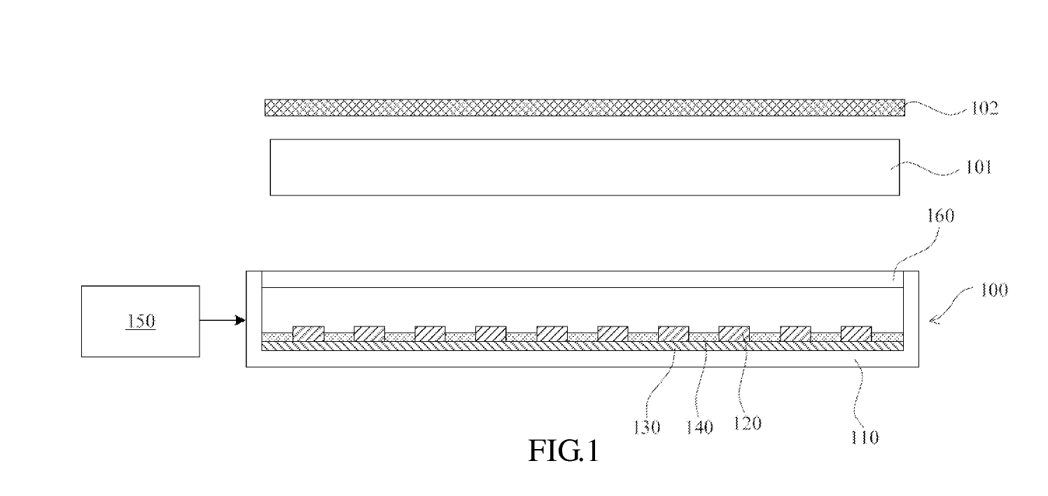

Referring to FIG. 1, a cross-sectional view showing a display apparatus according to one embodiment of the present invention is illustrated. The driving circuit 150 of the present invention can be used for driving a plurality of LEDs 120 of the backlight module 100. The LEDs 120 can be connected in series as at least one LED strip, so as to act as light sources of the backlight module 100. The backlight module 100 may be realized as a side-light type backlight module or a direct-light type backlight module disposed opposite to a display panel 101 (such as an LCD panel), thereby forming a display apparatus (such an LCD apparatus).

Referring to FIG. 1 again, in this embodiment, the display apparatus can be switched between a 2D image mode and a 3D image mode in accordance with a user's needs for displaying 2D/3D images. At this time, the display apparatus may further comprise a parallax barrier panel 102. The display panel 110 is configured to display 2D images, and the parallax barrier panel 102 is disposed at one side of the display panel 110 for forming a parallax barrier effect in the 3D image mode, and thus a 3D image effect can be formed by using the parallax barrier plate 102. However, in other embodiments, the parallax barrier effect or the 3D image effect may be formed by using other methods but not limited to the above description.

Referring to FIG. 1 again, in this embodiment, the backlight module 100 may be the direct-light type backlight module which comprises a back bezel 110, the plurality of LEDs 120, a circuit board 130, a reflective layer 140, the driving circuit 150 and at least one optical film 160. The back bezel 110 is configured to carry the LEDs 120 and the circuit board 130. The LEDs 120 can be disposed on the circuit board 130 and electrically connected to the driving circuit 150 through the circuit board 130 for emitting light rays to the display panel 101. The circuit board 130 may be a printed circuit board (PCB) or a flexible printed circuit (FPC). The reflective layer 140 is formed around the LEDs 120 (such as formed on the circuit board 130 or the back bezel 110) for reflecting the light of the LEDs 120. The driving circuit 150 is electrically connected to LEDs 120 through the circuit board 130. The optical film 160 is disposed above the LEDs 120 for improving a light uniformity and a light efficiency thereof.

In another embodiment, the driving circuit of the present invention may be applicable to the side-light type backlight module (not shown).

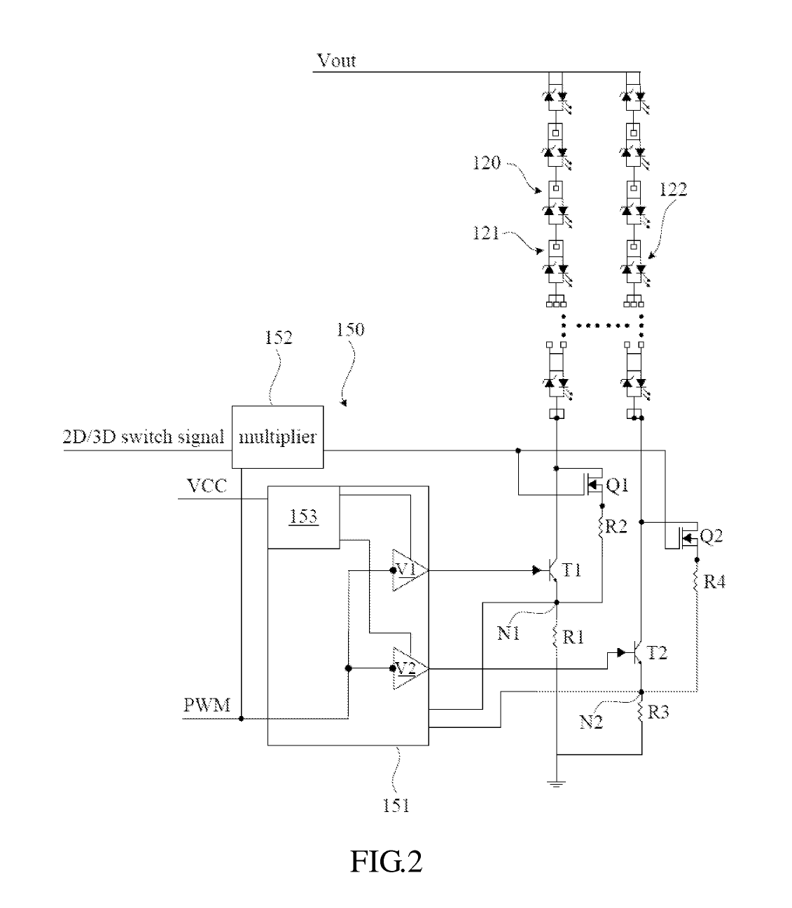

Referring to FIG. 2, a circuit diagram showing the driving circuit according to one embodiment of the present invention is illustrated. The driving circuit 150 of the present embodiment comprises a first transistor T1, a second transistor T2, a constant-current circuit 151, a first power switch Q1, a second power switch Q2, resists R1, R3, power resists R2, R4 and a multiplier 152. The transistors T1 and T2 are connected to the LEDs 120. The constant-current circuit 151 is connected to the transistors T1 and T2. The power resists R2 and R4 are connected to the transistors T1 and T2 in parallel, and the power switches Q1 and Q2 are connected between the transistors T1 and T2 and the power switches Q1 and Q2, respectively. The multiplier 152 is connected to the power switches Q1 and Q2, and a switch signal is transmitted to the power switches through the multiplier 152 for switching 2D/3D images. The switch signal can be referred to as a 2D/3D switch signal hereinafter.

Referring to FIG. 2 again, in this embodiment, the power switches Q1 and Q2 may be bipolar junction transistors (BJT) or metal-oxide-semiconductor field-effect transistors (MOSFET). A collector of the first transistor T1 is connected to a first LED strip 121, and an emitter of the first transistor T1 is connected to a first node N1, and a base of the first transistor T1 is connected to the constant-current circuit 151. A collector of the second transistor T2 is connected to a second LED strip 122, and an emitter of the second transistor T2 is connected to a second node N2, and a base of the second transistor T2 is connected to the constant-current circuit 151.

Referring to FIG. 2 again, in this embodiment, the constant-current circuit 151 may be a constant-current IC chip for stabilizing a current of the LEDs 120 such that the LEDs 120 can have a constant current. The constant-current circuit 151 can comprise a regulator 153 and amplifiers V1, V2. The regulator 153 may be a low drop-out linear regulator which is connected between a power source VCC and the amplifiers V1, V2. The amplifier V1 is connected to the base of the base of the first transistor T1, and the amplifier V2 is connected to the base of the base of the second transistor T2, wherein a pulse width modulation (PWM) signal is transmitted to the amplifiers V1, V2.

Referring to FIG. 2 again, in this embodiment, the power switches Q1 and Q2 may be depletion mode n-channel metal-oxide-semiconductor (NMOS) transistors. A drain electrode of the first power switch Q1 is connected to the LEDs 120, and a source electrode thereof is connected to the power resist R2, and a gate electrode thereof is connected to the multiplier 152. A drain electrode of the second power switch Q2 is connected to the LEDs 120, and a source electrode thereof is connected to the power resist R4, and a gate electrode thereof is connected to the multiplier 152. The resist R3 is connected between the emitter of the second transistor T2 and a ground. The power resist R2 is connected between the first node N1 and the first power switch Q1, such that the power resist R2 and the first power switch Q1 are connected to the first transistor T1 in parallel. The power resist R4 is connected between the second node N2 and the second power switch Q2, such that the power resist R4 and the second power switch Q2 are connected to the second transistor T2 in parallel.

Referring to FIG. 2 again, in this embodiment, the multiplier 152 can multiply the 2D/3D switch signal and the PWM signal, and provide the multiplied signal to the power switches Q1 and Q2 for switching. The 2D/3D switch signal can be provided by a controller (not shown) of the display apparatus of the present invention. The PWM signal may be provided by an external system (not shown), and is transmitted to the constant-current circuit 151 and the multiplier 152 by a timing controller (not shown).

Referring to FIG. 2 again, in the 2D image mode, the 2D/3D switch signal is multiplied by the multiplier 152, and then transmitted to the power switches Q1 and Q2. At this time, the 2D/3D switch signal is a signal of a low level, and thus the power switches Q1 and Q2 is turned off. Therefore, a current value of the LEDs 120 is equal to a current value of the transistors T1 and T2.

Referring to FIG. 2 again, in the 3D image mode, the 2D/3D switch signal is multiplied by the multiplier 152, and then transmitted to the power switches Q1 and Q2. At this time, the 2D/3D switch signal is a signal of a high level, and thus the power switches Q1 and Q2 is turned on. Therefore, the current value of the LEDs 120 can be a sum of the current value of the transistors T1 and T2 and the current value of the power resists R2 and R4, thereby increasing the current value of the LEDs 120, so as to raise a brightness of the LEDs 120 in the 3D image mode for preventing an inconsistency in the brightness of the display apparatus in the 2D/3D image mode. In this case, a current value of the LEDs 120 in the 3D image mode is substantially twice another current value of the LEDs 120 in the 2D image mode.

In this embodiment, a level of the 2D/3D switch signal in the 3D image mode is higher than another level of the 2D/3D switch signal in the 2D image mode. In this case, the signal level of the 2D/3D switch signal in the 3D image mode may be higher than 2.5 V, such as in the range of 2.5 V to 3.3 V, and the signal level of the 2D/3D switch signal in the 2D image mode may be lower than 0.8 V, such as in the range of 0 V to 0.8 V.

As described above, with the use of the driving circuit of the backlight module and the display apparatus using the same, a simple circuit can be used in the backlight module of the 2D/3D switchable display apparatus for raising the backlight brightness in the 3D image mode without increasing additional driving IC chip. Therefore, the driving circuit can be simplified, and only one driving IC chip is required, thereby enhancing a control accuracy of the driving current, as well as reducing a cost of the driving circuit.

The present invention has been described with a preferred embodiment thereof and it is understood that many changes and modifications to the described embodiment can be carried out without departing from the scope and the spirit of the invention that is intended to be limited only by the appended claims.

1. A driving circuit of a backlight module, comprising:
at least one transistor connected to light-emitting diodes (LEDs);
a constant-current circuit connected to the transistor;
a power resist connected to the transistor in parallel; and
a power switch connected between the transistor and the power resist, wherein a switch signal is transmitted to the power switch, and a signal level of the switch signal in a three-dimensional (3D) image mode is higher than another signal level of the switch signal in a two-dimensional (2D) image mode, and the signal level of the switch signal in the 3D image mode is higher than 2.5 V, and the another signal level of the switch signal in the 2D image mode is lower than 0.8 V.

2. The driving circuit according to claim 1, wherein the level of the signal level of the switch signal in the 3D image mode is in the range of 2.5 V to 3.3 V.

3. The driving circuit according to claim 1, further comprising a multiplier configured to multiply the switch signal and a pulse width modulation (PWM) signal, and to provide a multiplied signal to the power switch.

4. The driving circuit according to claim 1, further comprising a resist connected to the transistor.

5. The driving circuit according to claim 1, wherein the constant-current circuit comprises a regulator and an amplifier, and the regulator is connected between the power source and the amplifier, and the amplifier is connected to the transistor.

6. The driving circuit according to claim 5, wherein the regulator is a low drop-out linear regulator.

7. The driving circuit according to claim 1, wherein a current value of the LEDs in the 3D image mode is twice another current value of the LEDs in the 2D image mode.

8. A driving circuit of a backlight module, comprising:
at least one transistor connected to LEDs;
a constant-current circuit connected to the transistor;
a power resist connected to the transistor in parallel; and
a power switch connected between the transistor and the power resist, wherein a switch signal is transmitted to the power switch, and a signal level of the switch signal in a 3D image mode is higher than another signal level of the switch signal in a 2D image mode.

9. The driving circuit according to claim 8, wherein the signal level of the switch signal in the 3D image mode is higher than 2.5 V.

10. The driving circuit according to claim 9, wherein the signal level of the signal level of the switch signal in the 3D image mode is in the range of 2.5 V to 3.3 V.

11. The driving circuit according to claim 8, wherein the another signal level of the switch signal in the 2D image mode is lower than 0.8 V.

12. The driving circuit according to claim 8, further comprising a multiplier configured to multiply the switch signal and a pulse width modulation (PWM) signal, and to provide a multiplied signal to the power switch.

13. The driving circuit according to claim 8, further comprising a resist connected to the transistor.

14. The driving circuit according to claim 8, wherein the constant-current circuit comprises a regulator and an amplifier, and the regulator is connected between the power source and the amplifier, and the amplifier is connected to the transistor.

15. The driving circuit according to claim 14, wherein the regulator is a low drop-out linear regulator.

16. The driving circuit according to claim 8, wherein a current value of the LEDs in the 3D image mode is twice another current value of the LEDs in the 2D image mode.

17. A display apparatus, comprising:
a display panel; and
a backlight module comprising:
a back bezel;
a plurality of LEDs disposed on the back bezel; and
a driving circuit electrically connected to the LEDs, wherein the driving circuit comprises:
at least one transistor connected to the LEDs;
a constant-current circuit connected to the transistor;
a power resist connected to the transistor in parallel; and
a power switch connected between the transistor and the power resist, wherein a switch signal is transmitted to the power switch, and a signal level of the switch signal in a 3D image mode is higher than another signal level of the switch signal in a 2D image mode.

18. The display apparatus according to claim 17, further comprising a parallax barrier panel disposed at one side of the display panel.

19. The display apparatus according to claim 17, wherein the signal level of the switch signal in the 3D image mode is higher than 2.5 V.

20. The display apparatus according to claim 17, wherein the another signal level of the switch signal in the 2D image mode is lower than 0.8 V.
